(19) United States
(12) Patent Application Publication
(10) Pub. No.: US 2026/0017507 A1
(43) Pub. Date: Jan. 15, 2026

(54) IMPLEMENTATION OF RESTORATION MODELS

(71) Applicant: Microsoft Technology Licensing, LLC, Redmond, WA (US)

(72) Inventors: Francesca PARMIGIANI, Cambridge (GB); Hitesh BALLANI, Cambridge (GB); Kirill KALININ, Cambridge (GB); Christos GKANTSIDIS, Cambridge (GB); Jannes GLADROW, Cambridge (GB); Daniel Jonathan Finchley CLETHEROE, Cambridge (GB); Babak RAHMANI, Cambridge (GB); Jiaqi CHU, Cambridge (GB); Oscar Lawrence Spencer DAVIS, Oxford (GB); Douglas James KELLY, Sammamish, WA (US)

(21) Appl. No.: 18/934,157

(22) Filed: Oct. 31, 2024

Related U.S. Application Data
(60) Provisional application No. 63/669,227, filed on Jul. 9, 2024.

(51) Int. Cl. G06N 3/067

(52) U.S. Cl. CPC G06N 3/0675

(57) ABSTRACT

A diffusion model is implemented in the analog processing domain. Analog restoration model circuitry is configured to denoise an analog signal (referred to as ‘signal restoration’ processing). Analog noise injection circuitry coupled to the analog restoration model circuitry receives the denoised signal and injects an amount of noise back into it. The resulting noise-injected signal is fed back to the analog restoration model circuitry for further signal restoration processing, and the resulting signal is again passed to the noise injection circuitry for noise injection. Various mechanisms for implementing the noise injection stage in the analog domain are described. In a first example embodiment, a constant noise signal is applied with a variable scaling factor. In a second example embodiment, a variable noise signal is generated using analog noise generation circuitry.

### CROSS-REFERENCE TO RELATED APPLICATION

This application claims priority to U.S. Provisional Patent Application No. 63/669,227, entitled “IMPLEMENTATION OF DIFFUSION MODELS,” filed on Jul. 9, 2024, the disclosure of which is incorporated herein by reference in its entirety.

### FIELD

The present disclosure relates to the field of analog computation and machine learning.

### BACKGROUND

Deep neural networks can be used for a wide variety of applications, including image processing, machine translation, speech recognition, facial recognition, biological sequence analysis, etc. Neural networks comprise parameters (weights) which are typically learned in training based on large quantities of labelled training data comprising input vectors and corresponding outputs.

Diffusion models are an example of a deep neural network. Diffusion models are useful in many contexts, including image and audio generation, image denoising, and super-resolution. Diffusion models learn a latent structure of their training dataset by modelling the way the data diffuses in the latent structure as noise is added. Training a diffusion model typically involves a forward process of iteratively adding more noise to a training data item and learning how the data diffuses in the latent space as the noise increases, and then a reverse process of attempting to iteratively remove noise and converge on the original clean data.

In an image generation context, for example, the inference process after training involves providing an input vector indicating a point in the latent space, and a sample of pure noise. The pure noise sample is sequentially denoised to eventually converge on a clean image that is representative of the point in the latent space indicated by the input vector, thereby generating a new image. Different inputs are provided in other use cases, pure noise is given by way of example.

### SUMMARY

Herein, a diffusion model is implemented in the analog processing domain. Analog restoration model circuitry is configured to denoise an analog signal (referred to as ‘signal restoration’ processing). Analog noise injection circuitry coupled to the analog restoration model circuitry receives the denoised signal and injects an amount of noise back into it. The resulting noise-injected signal is fed back to the analog restoration model circuitry for further signal restoration processing, and the resulting signal is again passed to the noise injection circuitry for noise injection. Various mechanisms for implementing the noise injection stage in the analog domain are described. In a first example embodiment, a constant noise signal is applied with a variable scaling factor. In a second example embodiment, a variable noise signal is generated using analog noise generation circuitry.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 shows a schematic diagram of a diffusion model;

FIG. 2a shows a schematic diagram of a device implementing a diffusion model, including restoration model circuitry noise injection circuitry implemented in the analog domain;

FIG. 2b shows a device implementing a diffusion model comprising simplified noise injection circuitry;

FIG. 2c shows a device implementing a diffusion model, comprising noise injection circuitry configured to generate noise in the analog domain;

FIG. 3a shows a schematic block diagram of an analog system;

FIG. 3b shows an expanded view of a diffusion model in the analog system of FIG. 3a;

FIG. 4 shows a schematic diagram of an example opto-analog system for implementing a diffusion model;

FIG. 5 shows a schematic diagram of an example optical vector-by-matrix multiplier using spatial light modulators;

FIG. 6 shows a schematic diagram of an example electronic vector-by-matrix multiplier;

FIG. 7 shows a flowchart that represents a sampling process for a diffusion model implemented on analog hardware;

FIG. 8 shows a schematic block diagram of a computer system comprising an analog implementation of a diffusion model; and

FIG. 9 shows a schematic block diagram of an example computer system for use with the analog diffusion model implementation.

In the drawings, corresponding reference characters indicate corresponding components. The skilled person will appreciate that elements in the figures are illustrated for simplicity and clarity and have not necessarily been drawn to scale. Also, common but well-understood elements that are useful or necessary in a commercially feasible embodiment are often not depicted in order to facilitate a less obstructed view of these various example embodiments.

### DETAILED DESCRIPTION

In example embodiments described below, a diffusion model implemented in analog circuitry in the form of an iterative neural network that is implemented as a repeating cell that i) incrementally restores (de-noises) an input vector by application of a weight matrix to the vector of inputs and ii) injects an amount of noise to the restored vector at each iteration. That is, each time a vector is passed through the model, noise is injected to the output signal before the signal is provided back as an input to the model on a feedback loop. Performance of iterative neural networks at inference is improved if, after each pass through the model, a small amount of noise (small in magnitude in each vector dimension relative to the vector being passed through the model) is injected into the output vector before feeding the output back into the model. Alternating between incremental signal restoration and incremental noise injection (with the amount of injected noise reducing over time) yields better diffusion model performance, such as generating or modifying image data or audio data with fewer noticeable artefacts. Speed of processing is greatly improved with the analog implementations described herein. As such, performance of the underlying computing device is improved.

In one example, the noise injection process uses a fixed noise vector, sampled once and used in each iteration. Over time, after repeat application of the diffusion model and the noise injection process, the vector converges to an invariant output. Techniques for implementing diffusion models on analog hardware are described, including exemplary noise scaling techniques which improve the performance of the model and enable the analog system to converge on an output with minimal to no compromise in quality of outputs relative to digital systems. In one example, a noise scaling technique is described which uses a constant noise vector which is scaled over each iteration. The inventors have noted that implementation of diffusion models on analog hardware to provide convergent outputs is possible by implementing noise scaling with a constant noise vector.

Analog systems are orders of magnitude more efficient at matrix multiplication than GPUs. Implementing diffusion models on analog hardware can therefore bring advantages in computational efficiency, e.g., compute operations per watt, when performing tasks such as generating and processing images and audio.

Diffusion models have many applications, including generating and processing data such as images and audio. However, implementing diffusion models is a highly time and resource-intensive task, requiring large amounts of compute cost. This is at least in part because diffusion models are iterative and feed their outputs back in as inputs until an output is converged on. In particular, applying the huge number of weights (parameters) of a deep neural network requires high computational demand from GPUs or other specialized hardware that are implementing the model. Further, for a diffusion model to converge on a clean output, the number of repeat applications of the model in a feedback loop may be in the hundreds. This further increases the energy demand of image generation and other tasks that are performed using diffusion models.

Aspects of the present disclosure advantageously reduce the energy and computational demand of implementing diffusion models.

The high demand for time and computational resources in machine learning is due, at least in part, to the way that operations are performed in digital hardware. For example, in the digital domain operations such as multiplication and addition require complex arrangements of logic gates formed by components in the hardware (e.g., in a GPU), and require weights to be fetched from memory. Further, the speed of operations in digital devices is limited by clock cycles. Some computational tasks are performed much more efficiently in the analog domain than on digital devices. For example, analog signals (e.g., electric signals in a wire or light signals in an optical fibre) may be combined (e.g., added together, multiplied etc.) without requiring a complex arrangement of logic gates implemented on a powered digital machine. The signals can be manipulated with analog components and can propagate without the time limitations of clock cycles in a digital system.

Analog hardware is particularly advantageous in deep neural network applications. This is because the deep neural networks require large matrix multiplication operations to be performed, and such operations are an example of where the analog domain outperforms digital. Analog systems are orders of magnitude more efficient at matrix multiplication than GPUs. Implementing diffusion models on analog hardware can therefore bring advantages in computational efficiency, e.g., compute operations per watt, when performing tasks such as generating and processing images and audio.

Processing in the analog domain refers to processing signals in their natural continuous form. Processing of signals in the analog domain involves the use of analog hardware to manipulate physical properties of the signal, such as voltage, current, or frequency in electrical signals, or light intensity in optical signals. Outputs of processing operations are interpreted based on measurements of the physical properties that were manipulated.

The analog processing domain will be understood to include subdomains such as the electronic or electrical analog domain, and the optical analog domain. The electronic analog domain leverages physical properties of electrical signals in electrical hardware components such as wires and resistors etc. The analog optical domain leverages physical properties of light waves in optical hardware such as lenses, diffraction gratings, optical fibres, and the like. This selection of analog analog subdomains is provided by way of example only, and is a non-exhaustive list.

Processing in the digital domain refers to processing signals that are converted from their continuous analog form into a discrete form, e.g., 1s and 0s in binary code. Though discrete signals may be represented by electrical signals in wires, processing in the digital domain does not leverage physical properties of continuous signals in the wire, but instead requires an interpretation of the discretised signals based on clock cycles of the digital processing hardware.

The iterative nature of diffusion models makes them amenable to analog domain hardware implementations, which allow for feedback loops to be established. Inference tasks in diffusion models are accelerated a hundred fold by encoding diffusion models in analog hardware.

However, implementing diffusion models on analog hardware is not a trivial task. For instance, whereas digital systems can be halted after any number of iterations to read an output, analog systems evolve too quickly to read an output of a particular iteration without losing the advantages of using analog hardware. For example, reading an output requires averaging over a quickly evolving signal. To realise the advantages of analog hardware the model outputs should, over multiple iterations of a feedback loop, converge to an invariant output. This is a challenge that does not affect digital systems, since halting a digital machine to read an output is feasible.

Described herein are techniques for implementing diffusion models on analog hardware, including exemplary noise scaling techniques which improve the performance of the model and enable the analog system to converge on an output with minimal to no compromise in quality of outputs relative to digital systems. In particular, a noise scaling technique is described which uses a constant noise vector which is scaled over each iteration. The inventors have noted that diffusion models may be successfully implemented on analog hardware to provide convergent outputs by implementing noise scaling with a constant noise vector. In other examples, an analog hardware noise generator is provided as part of the device implementing the diffusion model. A mechanism for controlling variance of the noise is also provided. One example of an analog hardware noise generator is a hot resistor, wherein temperature is varied to reduce variance of noise. Another example is a noisy transitory junction, coupled to signal amplifier. In this example, the level of amplification is reduced to reduce variance of noise.

Before providing examples of analog devices and systems on which a diffusion model may be implemented, the following outlines a typical process of training a diffusion model, and provides example formats of inputs and outputs to the model.

In training a diffusion model, noise is added to an initial image, creating a noisy image. The model learns to recover the initial image from the noisy image by learning to remove noise. In a reverse process of removing noise, the model performs multiple iterations, where each iteration involves a denoising step. The denoised image output at each iteration is provided as an input to the next iteration. Various techniques for denoising are known. Parameters of the model are adjusted during training to minimise the difference between the denoised output and the initial image.

At inference, when the diffusion model is trained and deployed, the model may take input of a noisy image (e.g., one that was not seen during training), and perform the noise removal process learned during training to produce a clean image.

Inputs to a diffusion model may comprise encoded representations of a noisy image. Typically, an image is encoded as a pixel array. Each pixel of the image is represented by a value indicating a colour (e.g., in RGB colour images) or a shade (e.g., in greyscale images). In colour images, three channels are used to represent colour, and each pixel is a combination of three intensity values (one for each colour). A colour image may be represented by a 3-Dimensional pixel array, where the dimensions are of height x width x channel. A greyscale image has only one channel (black/white shade), and may therefore be represented by a 2-Dimensional pixel array having height and width dimensions and a single value representing shade intensity at each pixel. By convention, colour channel intensities are often defined within a range of 0-255.

Before images are fed into a diffusion model, the pixel arrays typically normalized to a common range, e.g., [0, 1], or [−1, 1].

A vectorization process may also occur before input to the model. In this step, the pixel arrays are flattened into 1-Dimensional vectors by concatenating rows or columns. A 1D vector represents the entire image as a sequence of features.

In other examples, diffusion models operate on image tensors as inputs and outputs. That is, the noisy input image is represented as a tensor; e.g., a 2D or 3D array for colour and greyscale respectively. Again, each value in the tensor corresponds to an intensity of a pixel in the one (greyscale) or three (RGB) colour channels. Within the model, various tensor operations, such as convolutions, activations, and normalisations, are applied to process the input and generate the output.

Output denoised images may similarly be represented as image tensors, e.g., with the same dimensions as the output. Outputs of different dimensions may be provided though, such as in examples where the diffusion model implements image upscaling.

Diffusion models have also been implemented using adjusted transformer architectures. Adjustments are made for implementing diffusion timesteps, for example. Like other transformer models, a diffusion transformer (DiT) may operate on token sequences. Such DiTs therefore apply transformation operations to the image representation (e.g., image tensor) to fit the token-based architecture.

To transform an image tensor to fit the token architecture, an image is divided into non-overlapping patches, or tokens. Each patch (token) is treated as a sequence of features and the patches are linearly embedded to create a token embedding. Positional encoding conveying the order of the tokens, and attention mechanisms for capturing global context may also be implemented to fit the transformer architecture. The token sequence is inputted to the model during inference, and an output token sequence is generated in turn. The output token embeddings are then decoded back into a denoised output image.

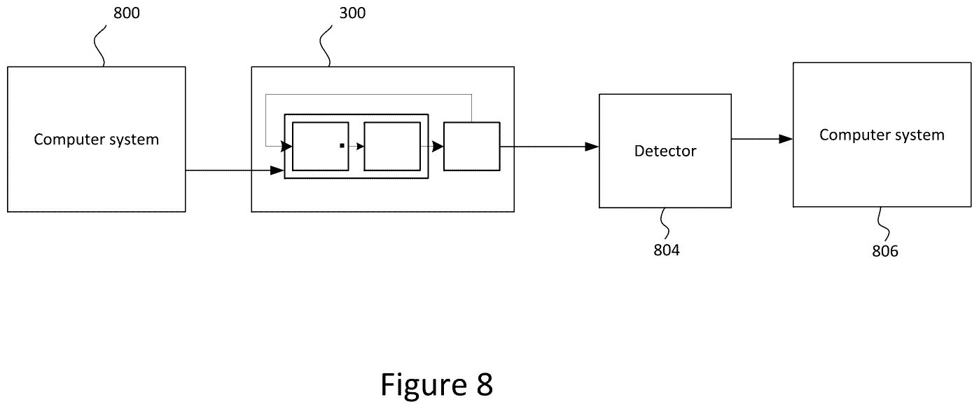

In the examples herein, the processes that take place in the diffusion model are carried out by hardware in the analog domain. However, pre-processing techniques for generating and decoding token sequences may be performed in the digital domain. Wider systems that leverage processing in the digital and analog domains are later described with reference to FIG. 8.

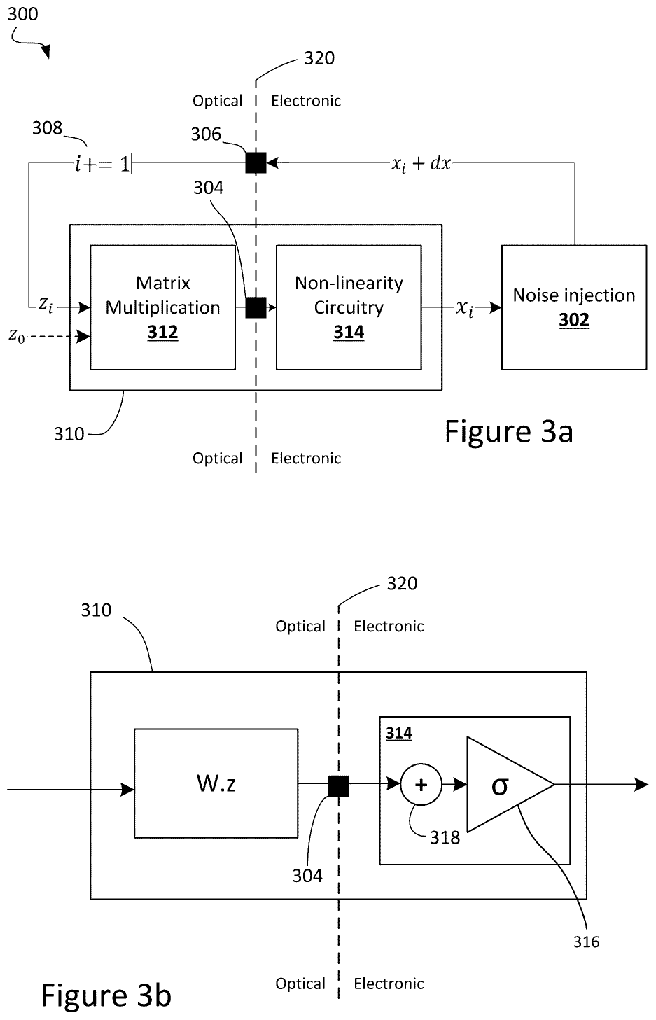

The description that follows provides examples of analog systems on which a diffusion model may be implemented. Techniques for optimizing the inference process for diffusion models implemented on analog hardware are also discussed later herein. The exemplary architectures and hardware structures outlined in FIGS. 3-6 are provided as non-limiting examples. The present techniques may be applied in other analog hardware systems to enable implementation of diffusion models therein.

The term diffusion model refers to an overall iterative feedback process of incrementally denoising an array of signals representing a vector and subsequently injecting noise. The diffusion model comprises hardware circuitry implementing the iterative process. The term restoration model refers to abstract weights of a model for performing the denoising step in the diffusion mode. The abstract restoration model is implemented on restoration model circuitry in the analog domain.

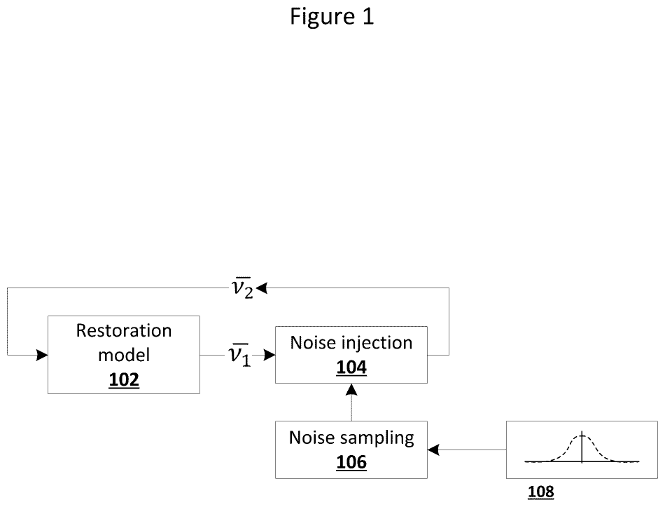

Reference is made to FIG. 1, which shows a highly schematic block diagram of a known diffusion model implementation in the digital domain. Block 102 represents a trained restoration model implemented on digital hardware, which performs matrix operations on input vectors based on encoded weights of the model 102. Blocks 104-108 represent intermediate processes between receiving an output of the model 102 and feeding the output back into the model 102.

Block 104 represents a noise injection process. In many cases, performance of iterative neural networks at inference is improved if, after each pass through the model, a small amount of noise is injected into the output vector before feeding the output back into the model.

The noise injection process 104 is followed by another iteration through the model 102. From left to right, FIG. 1 represents a first iteration through a restoration model 102, resulting in an output vector v̅₁̅, then a noise injection process 104 wherein noise is added to the produce a modified output vector v̅₂̅. The modified output vector v̅₂̅ is then passed in a feedback loop back into the restoration model 102 for a second iteration of the model.

The noise injection process 104 involves generating a noise sample, as denoted by block 106. The noise sample may be generated from a gaussian distribution 108, e.g., using digital hardware to model a gaussian distribution from which a sample is taken. Techniques for sampling noise in these ways are known. The noise sampling step 106 is repeated with each pass through the restoration model, such that a different noise vector is combined with the output vector (e.g., v̅₁̅) of each iteration of the restoration model 102.

The noise sampling process 104 of FIG. 1 does not represent a constant noise or fixed noise injection process, since a new noise sample is taken at each iteration.

Over time, after multiple iterations of the restoration model 102, the output vector of the restoration model 102 converges on a final output. Convergence is achieved by the feedback circuitry 230 maintaining coupling of the second output 228 to the first input 223.

FIG. 1 shows a high-level block diagram outlining the principles of diffusion model implementation. Other steps than those represented in the drawing may also be taken. Non-linearity operations, for instance, may be implemented to normalize output vectors.

As discussed above, implementing a diffusion model in analog hardware is a non-trivial task. In particular, noise injection processes are difficult to encode in the analog domain. For example, digital noise sampling is too slow to resample on the time scale on which the analog hardware operates.

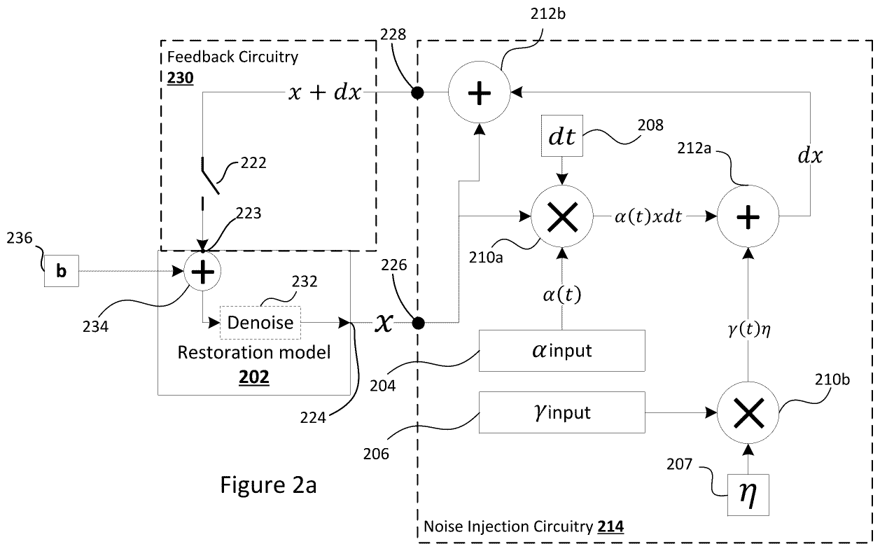

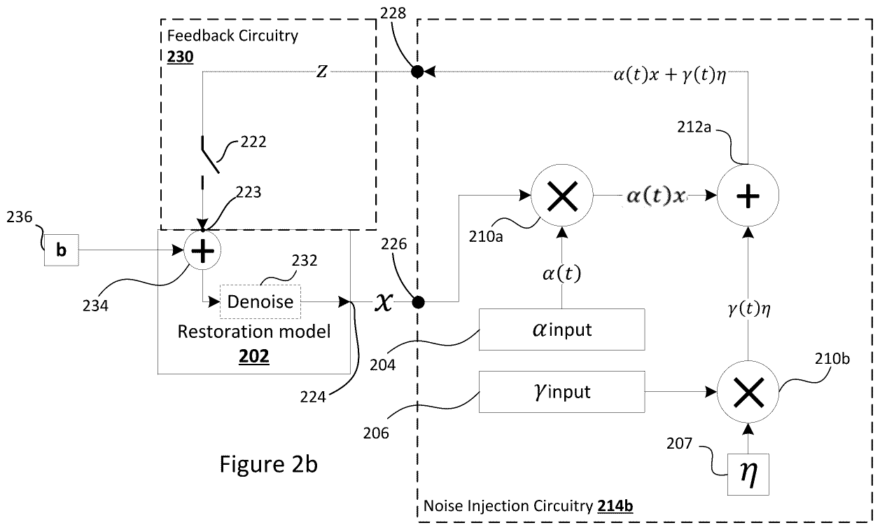

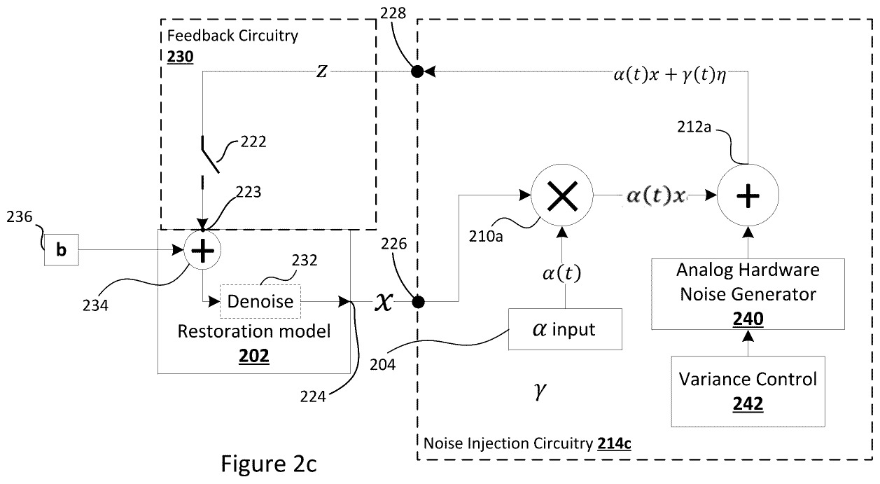

FIG. 2a shows an example device implementing a diffusion model in the analog domain. The diffusion model includes a restoration model 202 implemented in analog restoration model circuitry configured to denoise a signal passing through the model. The diffusion model of FIG. 2a further comprises analog noise injection circuitry 214 configured to implement a noise injection process in the analog domain. The diffusion model further comprises feedback circuitry 230 configured to route signals back to the restoration model after each iteration. A switch 222 is shown as part of the feedback circuitry to close the circuit and initiate the iterative process in the device. The model may work with any random initial state that the device finds itself in.

Block 202 of FIG. 2a represents analog restoration model circuitry. The restoration model circuitry 202 of FIG. 2a comprises denoising circuitry 232 configured to perform an incremental denoising step. The restoration model circuitry 202 of FIG. 2a further comprises an analog bias term summer 234 configured to add a bias term 236 to signals passing through the model 202. The bias term 236 is shown to be introduced in the model 202 by way of example. In practice, a bias term 236 may be introduced at any point in an iteration through the device. The bias term 236 is encoded in the analog processing domain as an analog biasing signal.

The restoration model 202 comprises analog matrix multiplication circuitry configured to apply trained weights of the model to an analog signal array representing an input vector. The restoration model 202 comprises a first input 223. The first input 223 comprises analog circuitry for providing signals received along feedback circuitry 230 back to the restoration model 202. Restoration model 202 further comprises a first output 224. The first output 224 comprises analog hardware circuitry that receives signals output from the restoration model.

In some examples, as discussed later herein, restoration model 202 is implemented as optical matrix and/or tensor multiplication circuitry encoding weights of a restoration model, and additionally to electrical circuitry configured to perform non-linearity operations on analog electrical signals.

In FIG. 2a, x denotes an output analog signal array, representing an output vector of the restoration model 202 which is output via first output 224. The output vector is encoded in an analog signal, referred to as an analog denoised signal. For clarity in FIG. 2a, a single line is drawn between each component, and the description refers in places to a single signal. In practice, however, a plurality of signals forming a signal array is represented by the output analog signal x. The same is true of the input signals z referred to later herein. This point is trivial though, since output signals x are provided back to the model as inputs z after the noise injection process.

Analog noise injection circuitry 214 is applied to the output signal array x, and injects noise after each iteration of the restoration model 202. The analog noise injection circuitry 214 comprises instances of analog multiplication circuitry 210 and analog addition circuitry 212. The analog noise injection circuitry 214 comprises a second input 226 coupled to the first output 224 of the restoration model 202, and a second output 228 at which analog noise-injected signals are output. In the example of FIG. 2a, noise is injected in accordance with equation 1 below:

$$dx = α ( t ) xdt + γ ( t ) η + dW \qquad ( 1 )$$

Equation 1 defines the change (dx) in each signal of the output array x with each iteration of the model, caused by the noise injection circuitry 214. The change in output signal is dependent on several terms: α(t), dt, γ, η, and dW.

Overall however, the noise injection operation transforms the output signals x as x→x+dx, where dx is defined above in equation 1.

In equation 1 the α(t) term controls how much signal x from the previous iteration is retained at each step. The γ term is a scaling factor which varies over time (e.g., with successive iterations). The γ scaling factor is applied to a constant controlled noise sample denoted by term η, and therefore determines a time dependent scaling factor of the noise sample (η) that is injected into the output signals of the output signal array of each iteration. dW denotes a residual background noise of the analog circuitry. For example, some variation in the signal array x is caused by transmission of the signal along analog hardware such as wires or optical fibres, etc. The term dW represents an uncontrolled noise term. The noise injection circuitry 214 of FIG. 2a therefore does not include dedicated hardware for managing dW.

The constant noise term η denotes a fixed noise vector. This noise vector may be sampled in the digital domain from a modelled gaussian distribution or other distribution, as discussed above. As discussed below, in one example, a noise scale factor is calculated in the digital domain and converted to an analog noise scaling signal via a Digital-to-Analog Converter (DAC). Moreover, in the example of FIG. 2a the noise vector η is sampled once and re-used at each iteration. η is said to be constant because the signal representing η which is injected into x does not change with each iteration.

Over time, as the system iterates in feedback with itself, the a term may be scaled up such that an amount of signal retained from the output of the model tends to a factor of 1. By contrast, the γ term may scale down over time, such that a magnitude of fixed noise that is introduced at each iteration tends to zero. The dW term is uncontrolled and introduced to signals of the array based on background noise in the analog hardware. dW models the omnipresent, inherent noise of analog computation. The magnitude of the dW term is small but constant relative to the signal array that is iterating through the model. An output can be read from anywhere in the circuit, as once the system has converged, the signal on the first output 224 will match the signal on the second output 228. Convergence can be detected by reading out a series of analog signals from any point in the circuit, and detecting when the series of analog signals is no longer exhibiting substantial time variation (implying convergence at the first output 224 and the second output 228).

Whilst the noise vector η is a constant vector, with fixed relative magnitudes in each dimension, the injected noise is not constant in magnitude over each iteration, since the γ term controlling this magnitude scales with time.

FIG. 2a includes block 204, which represents circuitry configured to perform a calculation of the α term in equation 1. In one implementation, α is calculated in the digital domain and injected in the analog domain via a Digital-to-Analog Converter (or DAC). That is, some calculation is done in the digital domain before injection to convert the digitally calculated numbers into the numeric number space of the analog machine. Once in the analog domain, α is a vector which is combined with the signal vector. With each iteration, the a vector is rescaled in the digital domain before being injected in the analog domain. The circuitry represented by block 204 is coupled as an input to a first analog multiplication circuit 210a of the noise injection circuitry 214.

Block 208 represents a time dependence factor dt. dt is only mathematically present and is not a direct input parameter in the hardware. This is because the system does not behave like a differential equation, but rather discretely iterates a function. The two perspectives (differential equation and iterative function) is reconciled if dt is nominally set to 1.

Output signal array x passes from the restoration model into analog multiplication circuitry 210a. The signal x, and signals from blocks 204 and 208 are provided as inputs to the first analog multiplication circuit 210a and are multiplied together. The analog circuit 210a is configured to combine the inputs, and provide an output equal to the first term of equation 1: α(t)xdt.

Block 206 represents circuitry configured to perform a calculation of the γ term in equation 1. γ may be calculated in the digital domain and injected in the analog domain via a DAC. Similar to the α, calculation of γ is done in the digital domain before injection, to convert the digitally calculated numbers into the numeric number space of the analog machine. Once in the analog domain, γ is a vector which is combined with the signal vector. With each iteration, the γ vector is rescaled in the digital domain before being injected in the analog domain. This circuitry outputs a noise scaling signal (an analog representation of γ(t)) that defines a magnitude of a constant noise vector that is to be ‘injected’ to the output signal x. The circuitry represented by block 206 is coupled to a second analog multiplication circuit 210b of the analog multiplication circuitry 214, resulting in an analog scaled noise signal (an analog representation of γ(t)η).

Since α and γ are calculated in the digital domain and injected via a DAC, the schedule according to which α and γ scale is fully controllable.

As discussed below, and as is clear from equation 1, the term noise injection as used herein refers to modulation of signal x by performing vector multiplication and addition operations to incorporate some amount of noise. In some examples of the present disclosure, the noise is a constant noise vector η. The magnitude of the noise vector varies over time, as determined by the γ term.

Block 207 denotes an analog signal indicating a constant noise vector η. The noise vector 207 is sampled once and reused for each iteration of the diffusion model. In some examples, the fixed noise sample may comprise a sampled signal from a real hardware component, such as an amplified hot resistor. For instance, instead of a full vector, only a scalar could be injected to scale a constant noise vector that is created by the device itself. This would still allow control of the overall noise schedule. In some examples, sample-and-hold circuitry may be used to generate iteration-wise constant vectors on the device.

In other examples, a sample is taken in the digital domain and converted into an analog signal (e.g., via a DAC) for use in the noise injection circuitry 214. The constant noise term is sampled at the start of an inference process, and re-used throughout inference. The noise sample vector 207 is provided as an input to the second analog multiplication circuit 210b. The second multiplication circuit 210b comprises analog circuitry configured to receive a constant analog noise signal representing constant noise vector η.

Signals from blocks 206 and 207 are provided as inputs to the second analog multiplication circuit 210b and are multiplied together. The analog circuit 210b is configured to combine the inputs, and provide an output equal to the second term of equation 1: γ(t)η.

The outputs of the first and second analog multiplication circuits 210a, 210b are provided as inputs to a first analog addition circuit 212a. That is, the signals representing terms α(t)xdt and γ(t)η are input to circuitry 212a configured to perform an addition operation and output a signal representing α(t)xdt+γ(t)η. Ignoring the background noise term dW, which is not applied in a controlled fashion by dedicated circuitry, this output of the first analog addition circuit 212a represents dx.

The output signal x, from the restoration model, is routed as an input to the first analog multiplication circuit 210a, as discussed above. However, in the example of FIG. 2a, the output signal x is also routed as an input to a second analog addition circuit 212b. The signal dx, output from the first analog addition circuit, is also provided as in input to the second analog addition circuit 212b.

The second analog addition circuit 212b is configured to perform an addition operation on the inputs. Addition circuit 212b outputs a signal equal to x+dx, in line with the noise injection transformation described above. FIG. 2a shows second output 228 of the noise injection circuitry. The second output 228 is configured to output signals from the noise injection circuitry 214. Since x represents an output signal of a first iteration of the model 202, and dx represents a modulation of that signal before being fed back for a second iteration of the model 202, the output x+dx therefore represents a signal that is to be provided as a feedback instance of the signal x.

That is, signal x+dx is routed via second output 228 of the noise injection circuitry, via feedback circuitry 230, and back into the restoration model 202 for a next iteration of the model. Feedback circuitry 230 comprises analog circuitry for routing signal arrays between the second output 228 of the noise injection circuitry and the first input 223 of the restoration model. Feedback circuitry 230 couples the second output 228 with the first input of the restoration model circuitry 202.

Bias term 236 is shown in FIG. 2a to be injected via bias summer 234. The bias term may inject a vectorized prompt, i.e., a signal representative of a vector in the learned latent space of the model. Injecting a vectorized prompt biases the output of the model towards a desired output. The summation 234 can be anywhere in the circuit. A biasing input is optional, and the model operate completely at random in the absence of a bias term. For example, the model may be conditioned at training to generate outputs of a particular kind. By way of example, in image generation contexts a bias term indicative of a prompt for an output image is injected. In other examples, the model has no bias term injection but is trained on a specific task, such as generating random images in a specific image class.

FIG. 2b shows a second example device implementing a diffusion model. The device is similar in form to the example device of FIG. 2a. The device of FIG. 2b, however, implements simplified noise injection circuitry 214b. the simplified noise injection circuitry does not include a time dependent term dt multiplied within multiplication circuitry 210. FIG. 2b includes the restoration model 202, feedback circuitry 230, first input 223, first output 224, second input 226 and second output 228 of FIG. 2a.

The simplified noise injection circuitry 214b does not route signal x to second analog summing circuitry (e.g., 212b of FIG. 2a) in parallel with the circuitry for injecting α and η. Signal x, output from the restoration model 202 via first output 224, is multiplied (via multiplication circuitry 210a) by the α term generated at block 204, resulting in a signal α(t)x. This signal is combined (via summing circuitry 212a with the γ(t)η term output by second multiplication circuitry 210b, resulting in a signal α(t)x+γ(t)η. This signal is received at second output 228 of the simplified noise injection circuitry and is fed back via feedback circuitry 230 to the restoration model 202.

In the example of FIG. 2b, the input signal z to an n^{th} iteration is z=α(t)x+γ(t)η, where x is the output from the restoration model in the (n−1)^{th} iteration. In the example of FIG. 2b, the noise injection circuitry does not transform x→x+dx by calculating x and dx in parallel and summing the signals, as in FIG. 2a. Rather, in FIG. 2b, the signal x is transformed directly to α(t)x+γ(t)η.

FIG. 2c shows a third example device implementing a diffusion model. The third example device comprises an analog hardware noise generator 240, embodies as analog noise generation circuitry on the device, and further comprises a variance control mechanism 242 controllable to control a variance of the analog-generated noise (the ‘noise variance’). With a larger noise variance, the probability of introducing larger amounts of noise increases. Hence, in this case, γ(t) is controlled by reducing the noise variance as the system iterates though alternating signal restoration and noise injection processing. The example of FIG. 2c is shown to comprise noise injection circuitry 214c. Apart from the noise generation being performed by hardware 240 in the analog domain, and being controlled via variance control 242 The third example device of FIG. 2c is otherwise identical to the second example device shown in FIG. 2b.

In one example, the analog hardware noise generator 240 comprises a hot resistor and the variance control mechanism 242 comprises a temperature control. Reducing the temperature of the hot resistor reduces variance of the noise.

In another example, the analog hardware noise generator 240 comprises a noisy transistor junction coupled to a variance control 242 in the form of a signal amplifier. The level of amplification is reduced to cause a corresponding reduction in variance of noise.

Herein, x is used to denote an output signal of a restoration model. z is used to denote an input signal to a restoration model. Though the inputs and outputs are linked due to the iterative nature of the systems, equations herein may be defined in terms of x and/or z so as to simplify the equations.

An all-analog system for implementing iterative neural network based models, including diffusion models, is now described. The system comprises analog vector-matrix multiplication circuitry and non-linearity circuitry, through which signals are continuously fed back in a loop. By running an analog device in feedback, it can serve as a highly efficient solver, computing an output to the model quickly and efficiently. Furthermore, the attractor (e.g., convergent) nature of the model leads to greater resilience to analog background noise of the system, making the system robust to noise. This is because, at each iteration, the system is drawn closer to the attractor, so if noise is applied and the system state is pushed away from the trajectory, the attractor still brings the system to a fixed point. Attractors come with so called ‘basins of attraction’. As long as you are within this basin, you will end up at/close to the fixed-point if you iterate long enough. The attractor will work against the noise over time.

FIG. 3a shows a schematic block diagram of an example analog system 300 implementing a diffusion model. The diffusion model comprises a restoration model 310 implemented in the analog domain. The restoration model 310 in the example of FIG. 3a comprises vector-by-matrix multiplication circuitry 312 that encodes the weights of the model 310. The model 310 further comprises non-linearity circuitry 314 configured to implement a non-linear function of the model.

The analog circuitry encodes a restoration model in the sense that analog circuit components are configured to apply trained weights to the input signals to perform the function of a trained restoration model. As above, different architectures for implementing iterative models such as restoration models are possible, and the analog circuitry may be configured in accordance with different architectures.

The system 300 further comprises noise injection circuitry 302. Reference is made back to FIGS. 2a-2c, which shows more granular examples of circuitry which may form the noise injection circuitry 302. Note that the examples of FIGS. 2a-2c do not show nonlinearity circuitry 314 as part of the model 310. Note also that FIG. 3a does not explicitly show, for example, the first and second inputs 223, 226, or the first and second outputs 224, 228 of FIGS. 2a-c.

In FIG. 3a, z₀ represents a starting instance of the model 310. The starting instance represents a random state of the device from which the process starts. That is, z₀ may not be configured for input to the device by a user, but may rather represent a random starting state of the device. Subsequent iterations of the system use the overall output of the previous system iteration as an input. For instance, input zᵢ for iteration i is given by zᵢ=xᵢ₋₁+dx, where xᵢ₋₁+dx is the previous iteration output.

Application of the model 310 to the input zᵢ results in a signal xᵢ, where the index i denotes a number of iterations of the model. xᵢ denotes a model output after applying both the matrix multiplication circuitry 312 and the non-linearity circuitry 314.

An input z; is provided as an input to the model 310, which applies matrix multiplication operations 312 and non-linear operations 314 to produce output xᵢ. The noise injection circuitry 302 then modulates the signal xᵢ to inject a fixed noise vector to the output xᵢ, resulting in a modified signal xᵢ+dx. The modified signal is routed as a feedback instance to the model 310.

Reference numeral 308 indicates an incremental increase in index i. 308 does not represent circuitry or a component in the system. Increment 308 merely represents the iterative nature of the system. That is, in an example iteration, z₁ is input to the model, x₁+dx is subsequently output from the noise injection circuitry. Increment 308 denotes a change in notation back to input zᵢ, with incremented index. E.g., output x₁+dx is fed back as input z₂. Since the system is cyclical, the index incrementation 308 may be considered to occur at any point in the loop. For clarity and by convention, the increment 308 is provided before the input is returned to the model 310.

Though the circuitry of FIG. 3a is all analog, operations may be performed in different analog subdomains. For example, matrix multiplication operations may be performed in an optical domain, using optical hardware such as optical fibres, LEDs and other such components forming circuitry 312. By contrast, non-linearity circuitry 314 and noise injection circuitry 302 may be implemented in the electronic analog domain, using wires and electrical components such as resistors.

The logical transition between the optical and electronic analog domains are represented by boundary 320 in FIG. 3a. Boundary 320 does not represent a system component as such, but merely an abstract boundary between analog computational domains. Block 304 represents circuitry for transforming optical signals output by the matrix multiplication circuitry 312 into electrical signals for processing by the non-linearity circuitry 314. Similarly, block 306 represents circuitry for transforming electronic analog signals into the optical domain for feeding back into the optical matrix multiplication circuitry 312 in the model 310.

Examples of analog components and structures for implementing computational operations in the optical and/or analog domain are discussed later herein. Techniques for implementing blocks 304 and 306 to transform signals between electronic and optical domains are also discussed later herein. It will be understood that the example of FIG. 3a is given as a non-limiting example. For instance, matrix multiplication circuitry 312 may equally be implemented in electronic analog hardware, and the non-linearity circuitry and noise injection circuitry may be implemented in the optical domain.

Reference here to a signal (e.g., output signal) in practice refers to an array of sub-signals, wherein each sub-signal in the array represents a value in a vector. That is, neural networks operate on multi-dimensional vector inputs which comprise a magnitude for each dimension. In the analog domain, a vector is represented by a signal array, wherein each sub-signal of the array indicates a magnitude of the vector in a particular dimension.

In general, the term ‘array’ herein is used to refer to a set of analog signals having a certain measurable property that models a numerical value of a corresponding vector of values, while ‘vector’ is used to refer to the numerical values themselves. However, ‘vector’ may be used as a shorthand to refer to a set of signals representing a vector of values. Any reference herein to mathematical operations being applied directly to physical signals should be understood to refer to a physical transformation of the signals such that the measurable property of the transformed signals corresponds to a result of applying that mathematical operation to the set of numerical values modelled by the physical signals.

It should also be noted that a distinction is made herein between a signal in the abstract and any specific instance of a signal. The input and output signals of each of the components as discussed herein are not limited to any specific values, while any given instance of such a signal refers to the signal having a particular set of values. For example, a ‘starting instance’ of the input signal is used herein to refer to a first input signal input to a given element of the analog hardware, while a ‘feedback instance’ of the input signal is used herein to refer to the continuous input into the analog hardware from the output of the analog hardware.

Note that while FIGS. 3a and 3b shows a single line representing the direction of the analog signal between components of the system, the signals processed by the system are provided in the form of an array of multiple signals processed in parallel. It should be noted that, throughout the description, unless otherwise specified, references to an input or an output of any component of the analog system 300 are intended to refer to an array of inputs or outputs, and not to any individual signal.

FIG. 3b shows an example expanded view of the model 310 of FIG. 3a. In particular, the non-linearity circuitry 314 is illustrated at a more granular level.

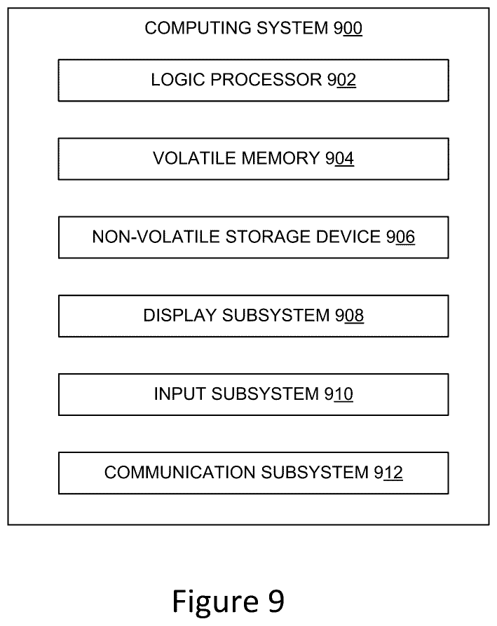

In FIG. 3b, matrix multiplication circuitry 312 is shown to comprise at least a vector-by-matrix multiplier (VMM) 402, but may comprise further analog components configured to apply other operations to a given analog signal. All signals processed by the system are analog signals (either electronic or optical signals), and no conversion to digital signals is applied during implementation of the restoration model 310 on the system 300, until conversion of the output signals for storage or communication to a digital computer system or detector, for example as described in FIG. 9. The VMM could be electronic analog circuitry comprising, for example, a matrix of programmable resistive elements such as floating gate field-effect transistors (FETs), reram, memristors, or active transistor multiplier elements, or alternatively an optical VMM implemented with optical components such as a spatial light modulator, ring resonator or Mach-Zehnder interferometer. Some of these examples of electronic and optical vector-by-matrix multiplication components are described in further detail below. Analog vector-by-matrix multiplication hardware is also described in International Patent Application nos. PCT/US2022/014172, PCT/US2022/014173, and PCT/US22/014174, which are hereby incorporated by reference herein in their entirety.

In FIG. 3b, the non-linearity circuitry 314 comprises addition circuitry 318, which is configured to add a bias term b to an output of the matrix multiplication circuitry 312. The bias term b is constant at each iteration. Overall, the non-linearity circuitry performs non-linear operations on the signal. However, linear operations like addition form constituent parts of the non-linearity circuitry.

As discussed below, the constant bias term may be absorbed into the matrix multiplications applied by matrix multiplication circuitry 312. In this case, the addition circuitry 318 may be omitted.

The non-linearity circuitry 314 of FIGS. 3a-b further comprises non-linear circuitry 316 for performing a non-linear activation function σ on the output of the addition circuitry 318.

The following description provides an example update equation over an iteration in the system 300. Consider again that zᵢ denotes an input signal for a given iteration i of the system, and xᵢ denotes an output of the model 310 at the given iteration. Input zᵢ is first transformed to xᵢ by the model 310. The noise injection circuitry then injects noise to the model output xᵢ. After noise injection, the overall output of an iteration is xᵢ+dx. Since the outputs are provided as inputs to a next iteration, the input to the next iteration zᵢ₊₁=xᵢ+dx.

At a lower level, the input zᵢ for a given iteration is passed through the matrix multiplication circuitry 312, in which at least one matrix multiplication W·zᵢ is performed. The bias term b is then added, and the non-linearity operation performed. The operations of blocks 312 and 314 provide the model output xᵢ. Therefore, the model output for the iteration i can be written in terms of the corresponding input zᵢ. In particular, xᵢ=σ((W·zᵢ)+b).

Noise is then injected in accordance with equation 1 above to provide the next iteration input. Equation 1 defines dx in a transformation of x→x+dx. Therefore, the input to a next iteration i+1 is defined as:

$${z}_{i + 1} = {x}_{i} + dx ,$$

According to this equation, each updated input vector zᵢ₊₁ is determined by multiplying the previous input vector zᵢ by a set of weights, adding a bias term, applying a non-linearity operation (resulting in a model output xᵢ for the iteration), and then injecting noise before providing the new input zᵢ₊₁ as a feedback instance.

It is straightforward to ‘absorb’ a constant offset vector, such as the bias term b into a matrix, such as the matrix W and append a 1 to the vector to which the weight vector is applied in either of the above update equations, in order to define the update as a single matrix-by-vector multiplication. A row of zeros is also added to ensure that the matrix is square.

The weight vector in this case is replaced by a modified weight vector:

$$\tilde{W} = [ \begin{matrix}W & b \\ 0 & 0\end{matrix} ]$$

and the vector to which the weights is applied is modified as follows:

$$\tilde{z} = [ \begin{matrix}z \\ 1\end{matrix} ] , or \tilde{σ} ( z ) = [ \begin{matrix}σ ( z ) \\ 1\end{matrix} ] .$$

The update equation zᵢ₊₁=xᵢ+dx still holds here, though xᵢ may be redefined as

$${x}_{i} = \tilde{σ} ( \tilde{W} \cdot {\tilde{z}}_{i} ) .$$

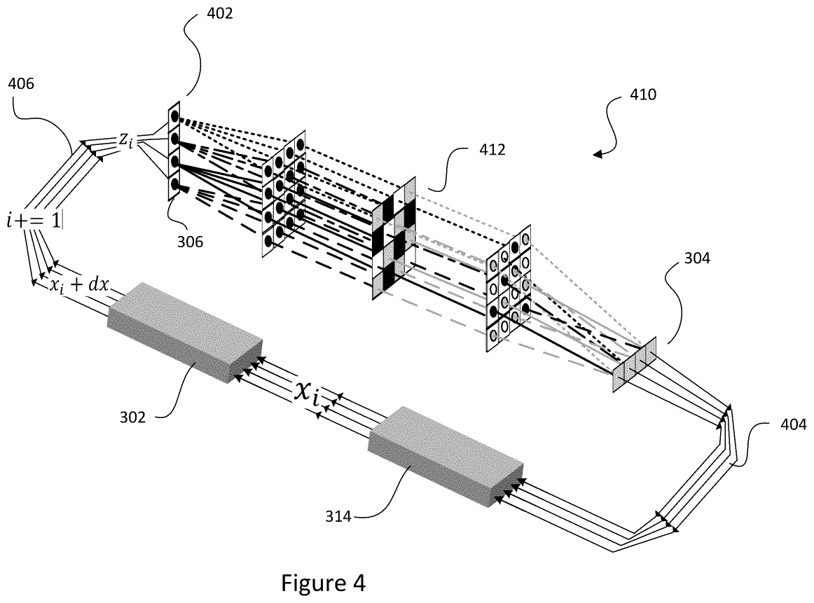

With reference now to FIG. 4, an example analog circuit to implement a diffusion model and noise injection process until the system converges to a solution vector (e.g., an output signal xᵢ that is invariant over iterations i) is now described.

The analog vector-by-matrix multiplication circuitry 410 (e.g., forming part of matrix multiplication circuitry 312 of FIGS. 3a-b) takes as an input an array of input signals 402, modelling a vector of input values to the multiplication, and transforms this input array, resulting in an array of transformed signals 404 that represents the result of a multiplication of the input values by the matrix of weights of a trained restoration model. As described above, the weight matrix may be a modified weight matrix that encodes both weights of a layer of the restoration model and bias terms. As discussed above, bias terms may provide a vectorized prompt to bias the signal towards a desired output. Alternatively, the bias terms are injected elsewhere in the feedback process of the diffusion model. The weights and biases are referred to collectively herein as the weights of the restoration model. The analog implementation of a restoration model takes the form of a cell defining a transformation applied continuously to a feedback signal. In an analog application of the example restoration model described above, the ‘cell’ may define a single layer of a neural network having a set of weights W which are applied to the input before computing a non-linear activation function of the resulting vector-by-matrix product.

A starting state refers to a first input to the weight matrix. This could be, for example,

$${\tilde{z}}_{0} = [ \begin{matrix}0 \\ ⋯ \\ 0 \\ 1\end{matrix} ] ,$$

such that the first term provided to the weight matrix only picks up the bias term b.
Other initialisations may be used, but some starting signal should be provided to the weight matrix to initialise the state of the system. As noted above, the initialization may be a random state of the system, and not directly controlled.

The state of the signals of the feedback loop at any given time (which are both output signals and input signals) are referred to herein as a system state.

The vector of signals of each instance (e.g., zᵢ) could be generated by an analog signal generator, such as a light source, for generating light signals, or an electronic signal generator. A measurable property of each of the generated signals corresponds to the numerical value of a respective one of the inputs of the model. For optical signals, the numerical values are represented by the intensity or the phase of the optical signal, while for electronic signals, current or voltage are used to represent the numerical values of the input.

When implemented by an analog system the values of the inputs/outputs of the model are updated continuously. That is, rather than applying a discrete iterative update of the values z over time as the signal is processed by the system 300, which could be described by the following equation:

$${z}_{t + 1} = W tanh ( {z}_{t} ) + b , \qquad ( 2 )$$

an analog system simulates the differential equation in its continuous form:

$$\frac{dz}{dt} = W tanh [ z ( t ) ] + b - z ( t ) . \qquad ( 3 )$$

The weights of the restoration model, like traditional deep learning models, are learned in training. Training is performed by a standard computer processor configured to perform digital signal processing in the digital domain. More details on training of restoration models are described, for example, in Song, Y., Sohl-Dickstein, J., Kingma, D. P., Kumar, A., Ermon, S., & Poole, B. (2020) ‘Score-Based Generative Modeling through Stochastic Differential Equations’, and in Ho J, Jain A & Abbeel P (2020), ‘Denoising Diffusion Probabilistic Models’. These training techniques will not be discussed in further detail herein.

The weights of the restoration model are encoded within the analog vector-by-matrix multiplier 410. For example, where the vector-by-matrix multiplier 410 takes the form of a spatial light modulator (SLM) 412, and where the input array 402 of signals is a set of intensity-modulated light signals, the modulators within the array of modulators of the SLM 412 are configured to adjust the intensity of the light by factors corresponding to the weights of the restoration model that were learned in training.

The system also comprises non-linearity circuitry 314 which applies a non-linear function to the signal after the weights have been applied to the input. The non-linearity circuitry 314 could comprise a series of analog components that apply different operations to the signal, with at least one operation being a non-linear activation function. It should be noted that the term ‘non-linearity circuitry’ is used herein to refer to any analog components or group of consecutive analog components that, overall, apply a non-linear function to the signal. The non-linear circuity 314 comprises at least an activation component (e.g., non-linear circuitry 316 which is configured to apply a non-linear activation function to the signal, meaning that the signal is transformed such that the property of the transformed signal takes the value of a result of applying a non-linear function to the numerical value modelled by the signal. However, the non-linearity circuitry could comprise other components such as an adder (e.g., addition circuitry 318) configured to add a constant value (e.g., bias term b) to the transformed signal before applying an activation function. As in the example above, one possible activation function is tanh. Another popular activation function used in typical neural network implementations is the rectified linear unit (ReLU), which is defined as follows:

$$ReLU ( x ) = max ( 0 , x ) = \{ \begin{matrix}x & if x > 0 \\ 0 & otherwise\end{matrix} .$$

Non-linear functions are implemented using analog electronic or analog optical circuits having components which can control properties of the electronic signal being transmitted, such as voltage and current, to apply the required function. For example, for the ReLU function, this behaviour is easily simulated in an analog electrical system by a diode, which outputs a current in one direction, but not the other, i.e. it allows a positive current to pass through but blocks negative current, thus implementing the function shown above.

FIG. 4 also shows noise injection circuitry 302, as described with reference to FIGS. 2 and 3. The output signal array of the noise injection circuitry is fed back into the matrix multiplier 410 as an input of a next iteration.

The VMM 410 and non-linearity circuitry 314 of FIG. 4 may be conceptually grouped as ‘the model’ 310 of FIG. 3a. The output of the non-linearity circuitry 314 in FIG. 4 is therefore labelled xᵢ, denoting a model output signal array. The noise injection circuitry 302 of FIG. 4 applies the transformation xᵢ→xᵢ+dx. This transformed output signal array (xᵢ+dx) is then provided as the input in a next input to the system. By convention, FIG. 4 shows an iteration index incrementation after the noise injection circuitry 302 outputs a signal array 406. Therefore, the next iteration output is equal to the output signal array of the noise injection circuitry 302 from the previous iteration, e.g., z₂=x₁+dx.

The output signal array 406 of the noise injection circuitry 302 is equivalent to the input signal array 402 in a next iteration.

As described above, the analog implementation of a restoration model is a continuous feedback loop through a cell which defines a transformation of the signal. The transformation of a single cell could correspond to a single layer of an infinite neural network architecture to which the restoration model is equivalent.

Feedback of the array of output signals (xᵢ+dx) as input signals (zᵢ₊₁) is implemented by way of a feedback path. This feedback path comprises hardware configured to route the output signal back towards the vector-by-matrix multiplication circuitry 410. In the case of an optical feedback loop, the feedback path could be implemented by waveguides, diffraction gratings, lenses and/or optical fibre cables, while for an electronic feedback loop, the feedback path is implemented by one or more electrical wires carrying the electrical feedback signal.

Alternatively, the cell could be composed of the transformations defined by multiple consecutive layers of a neural network, with the ‘block’ of multiple layers being applied continuously by the implementation of the restoration model. In this case, the non-linearity circuitry comprises more electronic and/or optical analog components such as transistors, resistors, diodes, switches, capacitors, modulators, splitters, etc. in order to implement arbitrarily complex compositions of functions corresponding to the mathematical functions of a cell of a restoration model applied after the vector-by-matrix multiplication.

It should be noted that the dimensionality of the array of signals remains the same throughout the process, and therefore that the combination of the vector-by-matrix multiplication circuitry, non-linearity circuitry, and noise injection circuitry is configured to produce an output array (xᵢ+dx) having the same number of signals as the corresponding (zᵢ) and next (zᵢ₊₁) input arrays. However, this does not limit the application of the diffusion model to inputs or outputs of a particular size, since unnecessary elements of the input and/or output can be treated as redundant and not used.

As described above, diffusion models are convergent, and after multiple iterations (e.g., hundreds of iterations) the output converges as a signal that is invariant under further iterations. At convergence, the values represented by the array of signals (i.e., the output vector x) become a fixed vector x*, i.e. once the values of the vector x have stopped changing, is also referred to herein as a solution vector. A convergence condition is defined after which the values of the vector x represented by the state of the system 300 are considered to have converged, and can be output by the system 300 to another system or to a user as the output of the diffusion model. At convergence, the input signal z is also invariant over further iterations. However, the input vectors z may not be suitable for reading out, since the noise injection circuitry adds noise to the output x to give the input z. Inputs z are therefore noisy relative to model outputs x. For this reason, the clean convergent output x* may be read out, instead of the noisy signal z.

Towards the end of the schedule, the artificially injected noise tends to zero and only noise stemming from the analog nature of the computation is being injected. This noise can be averaged out by sampling the converged signal for a short time until a sufficient signal quality is achieved. Sufficient signal quality may be considered to have been achieved after sampling for a predetermined length of time.

The convergence condition may be determined by a detector. This is achieved by comparing several measurements of the feedback signals. A sensor, such as a light meter or a multimeter may be used to measure the state of the system by reading the property of the analog signals to determine the value represented by the signals. Typically, the analog signal is converted to a digital signal as part of this measurement. A detector can be implemented in the form of software implemented on a conventional computer system to compare several measurements of the feedback signals after analog-to-digital conversion, or analog or digital hardware, that interprets the values represented by the signals as read by the sensor to determine that the signals of the system have converged.

One example convergence condition requires that at least two measured values of the vector x as modelled by the analog signals of the system are within a specified distance. A threshold distance may be defined, and the distance between the two measured values of the vector x is computed by evaluating the vector x based on the sensor readings of the property modelling the values of the vector and by computing a standard distance measure between the resulting numerical vectors. This computation may be carried out in analog hardware, or on software executed on a conventional computer system. Alternatively, a convergence condition may be defined that specifies a time after which the values of the vector x are expected to have converged to a fixed point. In this case, the detector comprises a time measurement device.

If the system has converged to a steady state, all signals of the system are static, and thus when the detector determines that any one array of signals of the system has converged, it is determined that the system state has converged to a steady state. However, the model output xᵢ should be read, since it provides a clean signal.

If the convergence condition is defined by a specified time having elapsed, then all signals are considered to have converged at that time. Convergence of the signals xᵢ can thus be detected by detecting convergence of any array of signals within the system. ‘Steady state’ refers to the state of the system once it has converged to within some tolerance of a fixed state.

The detector is also configured to output the values modelled by the signals as a solution vector of the diffusion model, once the system is determined to have converged. This may be achieved by receiving the values from the sensor used to measure the property of the signals that corresponds to the numerical values of the converged solution x* of the model.

References herein to ‘values’ of a vector or array of signals are intended to refer to the values of a given property of that signal chosen to represent numerical values in the context of the analog system 300. For example, a starting instance z₀ of the input vector 402 may be represented as a vector of light signals within the analog system 300, with the values of that starting instance 402 represented as intensities of the light signals, with those intensities being adjusted by the vector-by-matrix multiplier 410, the non-linearity circuitry 314, and the noise injection circuitry 302 over time until a final fixed set of intensities is reached, in the form of a solution vector signal.

Where the convergence condition is based on a measurement of the values of the array of signals, a measurement device (i.e. a detector) is used to measure the values of the analog property of the signals corresponding to the numerical outputs of the diffusion model. For example, where the values are represented by the light intensity of an array of light signals, a light meter can be used to detect the intensity of each light signal. This can be repeated multiple times, and the values compared, to determine whether the light signals have converged to a solution x*. In some embodiments, the detector is controlled or programmed by an external computer system to measure the signals at specific times and to compare the measured values to determine whether the system has converged. This computer system may be a standard processor operating in the digital domain. When it is determined that the system has converged to a solution x*, this may be output by the external computer system to a user or to another application or computer system. For example, where the diffusion model implements an image generation model, the vector representation of the output image, as measured from a vector of signals by the detector, may be passed to a computer system to display the image to a user, or to input the image to a further application. The term ‘detector’ is also used herein for any device or component configured to identify when the convergence condition is met. For example, where a convergence condition is defined as a time after which convergence is expected, the detector used to determine that the convergence condition is met may comprise a clock or other device configured to measure time.

As described above, the implementation of the diffusion model by the system 300 is carried out entirely within the analog domain, but could include both optical and electronic components. Where parts of the system are implemented as optical hardware, the signals are converted from electronic signals to optical signals for processing by the optical hardware, before being converted back to electronic signals for processing by electronic components.

It should be noted that the term ‘circuitry’ is used herein to refer to analog components configured to perform a particular function, and can include electronic circuitry, such as wires, transistors, resistors, diodes, transformers, etc., and optical circuitry, such as waveguides, optical fibres, diffraction elements, lenses, and modulators. The optical circuitry may use free-space optics, where light is directed through free space using lenses, diffraction gratings, etc., or integrated optics, where light is directed via optical fibre cables or other waveguides. In some embodiments, analog circuitry comprising a combination of electronic circuitry and optical circuitry is used.

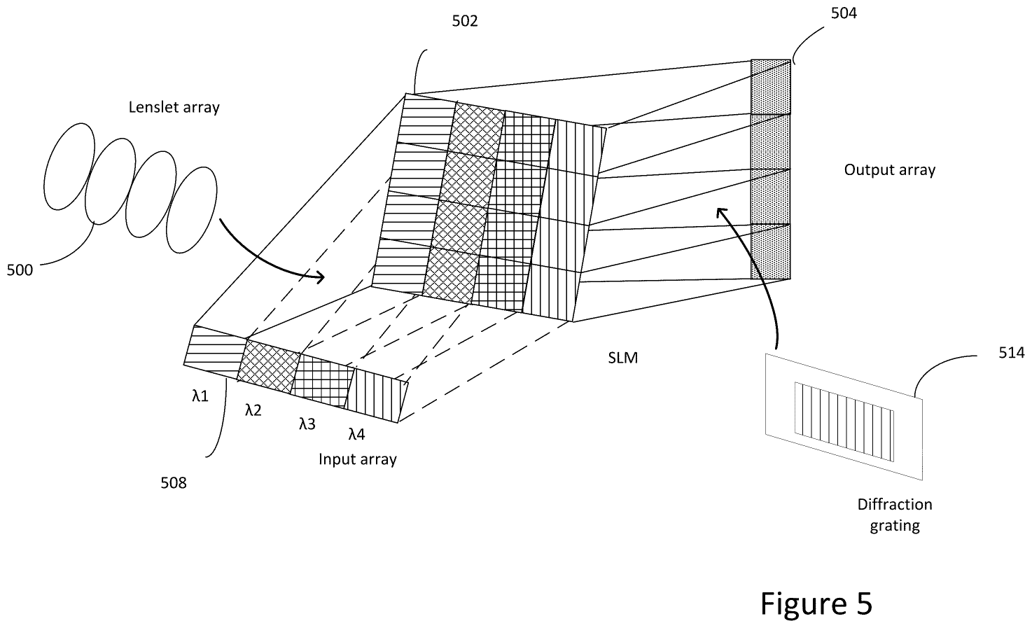

In the system of FIG. 4, the feedback signal 406 may reach the vector-by-matrix multiplication circuitry 410 as a vector of electrical signals, shown by the series of lines, which could be carried along electrical wires. The electrical signals are converted to optical signals by an electrical-to-optical converter 306, as discussed with reference to FIGS. 3a-b. This converter 306 could comprise, for example, a set of light-emitting diodes, which emit light at an intensity dependent on the current of the received electrical signal. In the present example, the vector-by-matrix multiplier is implemented using a spatial light modulator 412 and the signals are represented by incoherent light sources such as light-emitting diodes. This is described in more detail below, with reference to FIG. 5.

Simple matrix multiplication is defined as follows. For an input vector v=(v₁, v₂, . . . , v_{N}), and an N×N matrix A, the vector-by-matrix product is computed as:

$$Av = ( \begin{matrix}{A}_{11} & ⋯ & {A}_{1 N} \\ ⋮ & ⋱ & ⋮ \\ {A}_{N 1} & ⋯ & {A}_{NN}\end{matrix} ) ( \begin{matrix}{v}_{1} \\ {v}_{2} \\ … \\ {v}_{N}\end{matrix} ) = ( \begin{matrix}{A}_{11} {v}_{1} + {A}_{1} {v}_{2} + … + {A}_{1 N} {v}_{N} \\ {A}_{21} {v}_{1} + {A}_{22} {v}_{2} + … + {A}_{2 N} {v}_{N} \\ ⋯ \\ {A}_{N 1} {v}_{1} + {A}_{N 2} {v}_{2} + … + {A}_{NN} {v}_{N}\end{matrix} )$$

The input signals are spatially spread out horizontally across the width of the spatial light modulator, to provide input vectors for multiplication by each column of the weight matrix (i.e. row of the spatial light modulator in the implementation shown in FIG. 4, though it will be appreciated that the configuration shown may be changed to a horizontal input vector, with a colour for each column of the spatial light modulator by simply rotating the entire multiplier configuration by 90 degrees). The elements of the spatial light modulator correspond directly to the elements of the weights of the vector-by-matrix multiplication of the restoration model. As described in more detail below, each element of the spatial light modulator is an individual modulator configured to apply a predetermined factor to the received signal at that modulator. This results in a matrix of signals in which each element of the input vector is multiplied by each respective element of the corresponding row of the weight matrix. These signals are added up along each column by combining the resulting array of signals in the vertical direction, resulting in a vector of light signals, which are detected by a photodetector or other optical-to-electrical converter 306 configured to measure the intensity of the light signal and convert it to an electrical signal having a proportional current.

In the example shown in FIG. 4, the non-linearity circuitry 314 is implemented within the electronic analog domain, receiving the electrical signals as a vector and applying a preconfigured electronic circuit to implement the non-linear function defined for the given restoration model to the output of the VMM 410. As described above, the non-linear function applied by the non-linearity circuitry 314 could be a composition of multiple functions, which includes at least one non-linear activation function, such as tanh(x) or ReLU, but could also include, for example a further matrix multiplication, or the addition of a constant.

FIG. 5 shows an example optical VMM for computing vector-by-matrix multiplication as part of an analog implementation of a restoration model. This configuration comprises an input array 508 of light sources, a micro-optics array 500, a spatial light modulator (SLM) 502, a second micro-optics array 514 and an output array of light signals which are detected at an array of photodetectors, not shown in FIG. 5.

To use a spatial light modulator for vector-by-matrix multiplication, the vertical axis of the SLM needs to provide different weights even for the same optical source, so that the whole functionality of the vector-by-matrix multiplication is achieved. This is because, for matrix multiplication, the input vector needs to be multiplied by each row of the matrix A to generate the full output vector, as described above. The SLM 508 comprises modulators arranged in an array, with the losses applied by each modulator reflecting the weights of the matrix to be applied to the input, i.e. a row of the modified SLM encodes the weights in a row of a matrix W of weights of the restoration model. As described above, each element of the transformed vector of signals output by the VMM is computed by multiplying the input vector by a respective column of the matrix. Thus, each of the input signals needs to be processed to be spread out vertically such that they hit each row of the SLM 502, corresponding to a series of vector-by-vector multiplications.

A single input array 508 comprises the set of input signals (which could correspond to the starting instance zo or any feedback instance zᵢ (denoted 406 in FIG. 4). As described above with reference to FIG. 4, these signals may be generated using a set of light-emitting diodes (LEDs) configured to convert an electrical current into a light signal. This vector is passed through a micro-optics array 500 having a particular geometry that causes the signals to spread out vertically, while collimating the beam in the horizontal direction of the SLM 502. This allows more input signals to be simultaneously processed at a single SLM. A micro-optics array as in FIG. 5, enables scaling to more signals than a single signal. A micro-optics array improves the collimation properties of the beam in both directions.

The SLM 502 comprises a two-dimensional array of modulators, each element of the array applying a respective weight to the received input signal. A similar configuration is expected for the modulated signals after they are bounced off the SLM 502.

In embodiments, the output signals may be directed from the element 514 via one or more micro-optics, to direct the signals into a beam at the correct vertical height to be detected using incoherent addition at the photodetector corresponding to the output vector element represented by that beam. E.g., another micro-optics array may also be included before the photodetector array.

The photodetector array 504 is arranged as a set of photodetectors in a vertical array, each combined signal directed from the micro-optics element 514 corresponding with a different respective output signal of the vector of output signals. It should be noted that ‘input’ and ‘output’ are used with reference to FIG. 5 to refer to the input and output signals of the multiplication operation only.

An analog system 300 which uses a vector-by-matrix multiplier architecture described above allows simultaneous processing of multiple elements of an input vector of the restoration model. This may be further scaled to enable even larger numbers of inputs by splitting each beam into multiple beams which are directed to a configuration of multiple SLMs 502.

Optical vector multiplication has also been implemented by a number of existing technologies, such as spatial light modulators which use wavelength division multiplexing, ring resonators, and Mach Zehnder interferometers, as described in the Earlier Applications. Such technologies are also described for example in K. Kitayama et al, “Novel frontier of photonics for data processing-Photonic accelerator”, APL Photonics 2019, https://doi.org/10.1063/1.5108912., which is incorporated herein by reference in its entirety. SLM VMM implementations do not use wavelength division, and instead use a single optical source, and use coherent addition at the photodetectors to compute the weighted sum for each element of the output array.

As described above, the VMM can also be implemented by electronic analog components, such as an array of memristors, FETs, reram, or active transistor elements, which are configured to apply a multiplicative factor to an input voltage, generating an output current.

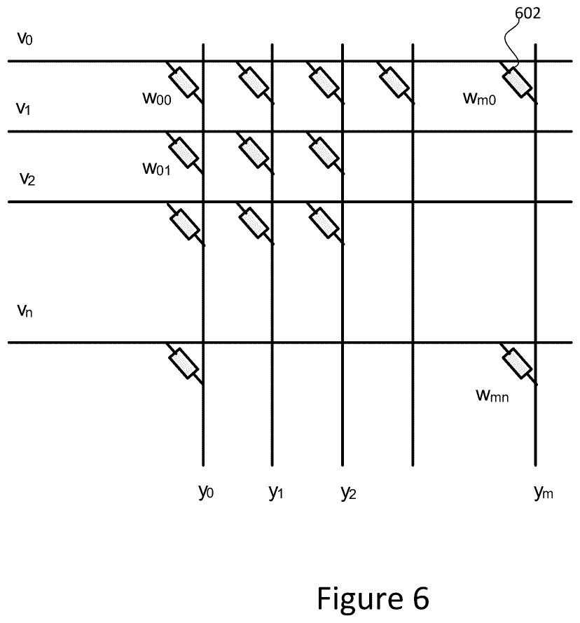

FIG. 6 shows an example implementation of an electronic analog vector-by-matrix multiplier for transforming a set of analog signals representing an input vector (x₀, x₁, . . . , xₙ) by a matrix of weights W_{NM}. It should be noted that the terms ‘input’ and ‘output’ in the present context refer to the direct input and output to the vector-by-matrix multiplier, and do not necessarily correspond to inputs and outputs to any model implemented in the system 300 described elsewhere herein. It will be understood that the input signals to the vector-by-matrix multiplication circuitry is dependent on the specific implementation.

In the example shown in FIG. 6, the input values are modelled by a voltage of the input signals. The matrix of weights is encoded by an array of resistive elements programmable to apply a fixed multiplicative factor to a property of each input signal. Each element of the array corresponds to a respective element of the weight matrix W. In this example, the matrix of weights is encoded by a crossbar arrangement of memristors 602, each memristor wᵢⱼ configured to receive an input signal having a voltage of vᵢ, and to output a current representing the multiplication of the weight corresponding to that memristor with the input signal vᵢ. This multiplication is based on Ohm's law. The output signal of each memristor 602 of a given column of the crossbar array is provided to an output channel for that column. The current of the signals is added by combining the signals. This is based on Kirchhoff's law The resulting currents are thus added along the columns to compute an array of output currents, the output current for each column representing a respective element of the output vector y.

A similar configuration could be used to implement electronic vector-by-matrix multiplication using other types of resistive elements, including floating gate field-effect transistors (FETs) or active transistor multiplier elements. It will be appreciated that the system described herein is not limited to any particular implementation of the vector-by-matrix multiplier, and that any analog circuitry suitable for applying multiplicative factors to modelling properties of analog signals and adding the resulting signals can be arranged to perform such an operation.

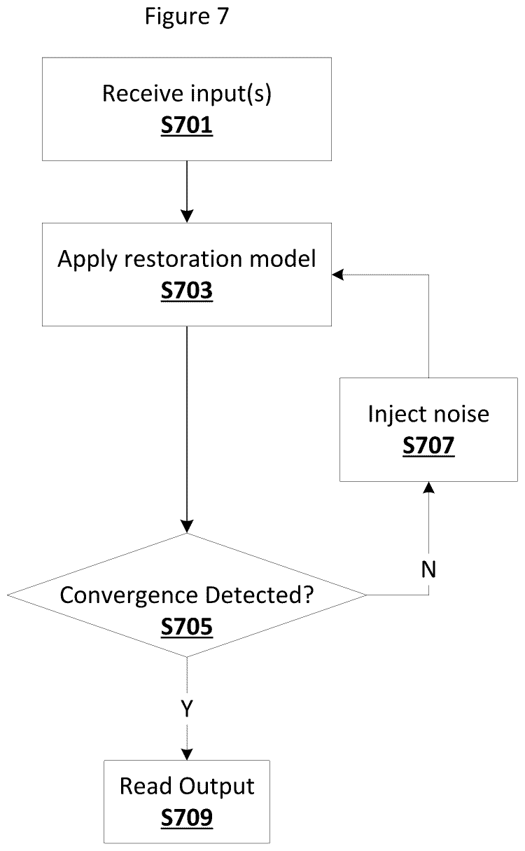

With reference to FIG. 7, the following description outlines an example inference process for generating an output of a diffusion model implemented on analog hardware. For example, the following process may be implemented on a combination of the analog computing components discussed above.

At a first step S701, model input is received. The nature of the input depends on such things as a task the diffusion model is configured to implement and an architecture of the model, as discussed above. The input may also be a feedback instance of an output signal. As discussed above, an initial state of the model may not be expressly provided by the user, but may be a random background state of the device.

After receiving the model input, the example flow progresses to a step S703, wherein the restoration model is applied to the inputs. In a first pass of the input through the model, the input is considered a ‘starting instance’, as discussed previously herein. The inputs, e.g., vectors, token sequences, or pixel arrays embodied as light or electric signals, pass through the components of the analog circuitry such that the parameters of the model are applied to the inputs. For instance, one or more matrix multiplication or tensor operation may be performed on the inputs by the analog hardware. The vectors could be embedding vectors for any conceivable entity that benefits from modelling through a diffusion model.

Referring back to FIGS. 3a-b and their description, the output of the restoration model is an instance of x. The overall inference process aims to pass feedback instances of the signal back into the model iteratively, until the output converges to a solution signal array x*. One example of how analog hardware provides advantages over digital systems is that each instance x need not be stored in memory to be provided back to the model as a feedback instance, thus realizing benefits in memory use.

At a next step S705, an assessment is made as to whether convergence on an invariant output x* has been detected. Over many iterations (for example, of the order of hundreds of iterations), the output signal array x converges to a solution signal array output x*. A detector 804 may be provided in the system to detect invariance of successive outputs. If successive output vectors are invariant, and thus the output has converged, the detector is triggered and cause the output to be read.

Where convergence is detected, step S705 returns TRUE, and the flow progresses to a step S709, wherein the final convergent output is read.

If no convergence is detected at step S705, a noise injection process is performed in step S707. Example noise injection processes are described above.

In one implementation, the restoration model is a neural network that is applied iteratively at inference time in feedback with itself. However, between receiving an output and providing that output back as input as a feedback instance, some amount of noise (e.g., gaussian noise) is added on each iteration. The noise that is added after each pass through the model is distinct from the noise removal process that the restoration model is configured to simulate, and is distinct from the initial model input, which may include a noisy signal to be denoised. That is, each iteration through the model comprises a step of removing noise (by application of the restoration model) and injecting some noise to the output of each iteration.

It has been noted that injecting some amount of noise after each iteration improves the performance of diffusion models.

In the present context of implementing diffusion models in analog hardware, the inventors have identified benefits to injecting noise based on a fixed noise vector. Known systems select a fixed noise vector, or opt to re-sample a noise vector after each iteration of the model. The inventors note that fixed noise is better suited for analog hardware implementations whilst providing minimal compromise on model outputs. That is, noise sample generation is too slow in the digital domain for a newly generated noise sample to be injected after each iteration through the restoration model.

Reference is made to FIGS. 2a and equation 1, which describes a fixed noise injection process implemented in the analog domain. The fixed noise injection process described herein enables diffusion models to be successfully implemented in the analog domain, with low to zero compromise in performance relative to digital implementations.

In some examples, a fixed noise vector is drawn once from a multivariate Gaussian in the digital domain. This noise vector converted by the DAC to a constant analog noise signal, and reused and injected at multiple time steps. As also discussed above, uncontrolled noise is injected at each timestep by the hardware itself. Analog circuitry acts to inject small amounts of background noise at each time step. As described above, the convergent attractor nature of the diffusion model acts against the injected noise to converge on a clean output.

Following the noise injection step S707, the flow progresses back to step S703, wherein the diffusion model is applied again. In this repeat instance, the input to the model is a feedback instance comprising the output of the noise injection circuitry, applied at step S707. In some examples, a bias term injection process is performed at some point in the iterative loop represented by steps S703, S705 and S707.

In some examples, an inference process may comprise steps of: receiving an input signal array comprising a plurality of analog input signals, each analog input signal of the array representing a respective weight of an input vector; and:
a. transforming the array of analog input signals using analog matrix multiplication circuitry, the analog matrix multiplication circuitry encoding a matrix of weights of a restoration model, to generate an array of transformed signals, each transformed signal of the array of transformed signals modelling a respective value of a matrix product of the input vector and the matrix of weights;
b. providing the array of transformed signals to noise injection circuitry which applies a constant noise vector to the array of transformed signals, resulting in an array of output signals;
c. routing the array of output signals to an input of the analog matrix multiplication circuitry, as an array of analog input signals;
d. reducing a magnitude of the constant noise vector that is applied by the noise injection circuitry; and
e. repeating steps a)-d) until the array of output signals satisfy a convergence condition.

The inventors have noted that diffusion models implemented in the analog domain according to techniques described herein indeed converge at the end of their schedule (e.g., after multiple iterations). This enables an output value to be read out after sufficient iterations without averaging a time-variant signal over two or more iterations and compromising on output quality.

An example system utilising a diffusion model implementation in the analog domain in combination with digital computer systems is shown in FIG. 8.

A restoration model of the diffusion model may be trained by the computer system 800 shown in FIG. 8, or some other computer system, using a software program for training a restoration model by simulating diffusion of data points across a latent structure and learning to reverse the diffusion process as mentioned above. The weights of the restoration model are determined and used to configure the vector-by-matrix multiplication circuitry and/or the non-linearity circuitry of the analog system 300 to implement the weights. The inputs of the restoration model are received via a computer system 800 and used to configure the weights of the VMM. For an example image generation application, the input is a segment of text from which an image should be generated. This could be input to the computer system 800 by a user of the computer system 800, or received by the computer system from a database or cloud-based system. The computer system 800 is a conventional computer system comprising memory and processors configured to perform computation in the digital domain. The computer system may apply some pre-processing steps to convert the input text to a numerical vector representation. This can be achieved by applying a trained word embedding model to convert an input text into a numerical vector. Other transformations may be applied to the numerical vector before converting the vector into analog form. The analog system 300 may be manually configured to implement the weights (and optionally bias terms) of the restoration model by manually adjusting the components of the vector-by-matrix multipliers, such as the light modulators, resistors, memristors etc., or a computer system may be configured to control the relevant properties of the components automatically based on the trained weights. A program can be applied to reformulate the trained models in such a way that they can be written to the spatial light modulator, or any other hardware implementation of a VMM. A starting input array is also provided to the analog system 300.

FIG. 8 includes analog system 300 in accordance with the example of FIGS. 3a and 3b.

The analog system 300 processes the input analog signals continuously as described above, until some convergence criteria on the signal values is met. As mentioned above, in preferred embodiments, the convergence criteria are based on multiple measurements of the measurable property of the signals representing the underlying numerical values of the restoration model. For example, convergence criteria may be determined to have been met once a detector determines that two or more measurements of the feedback signals, measured a predetermined time interval apart, are within some threshold distance of each other.

A detector 804 is used to measure the values represented by the signals. As described above, the array of signals correspond to a vector of numerical values representing the output of the diffusion model. The detector 804 determines convergence of the system, which could be based on the measurements of a sensor or based on some other convergence criteria such as an elapsed time and outputs the system state, i.e. the values represented by the feedback signals, once the system has converged, to a further computer system. Various types of sensors may be used, such as an ammeter, which measures current, or a light meter which measures light intensity. As described above, the detector may be implemented as a software program implemented on a conventional computer system, by analog hardware such as electronic circuits comprising resistors, transistors, diodes, wires, etc., optical hardware including optical fibres, waveguides, lenses, diffraction elements, modulators, etc., or digital hardware such as FPGAs, program-and application-specific integrated circuits (PASIC/ASICs), program-and application-specific standard products (PSSP/ASSPs), system-on-a-chip (SOC), or complex programmable logic devices (CPLDs), or some combination of software, analog hardware and/or digital hardware. While shown as a separate component of FIG. 8, the detector may be implemented on computer system 800 or computer system 806. The output of the diffusion model as output by the detector 804 is a vector of numerical values.

However, the application to which the diffusion model is applied may require an output of a different format. In the example of image creation, for example, the output is a vector of numerical values which can be mapped to an image. To generate the image, the numerical values of the signals detected by the detector 804 are output to a computer system, which can apply further transformations to the numerical solution vector to convert it to an image. For example, a trained decoder architecture may be configured to convert the numerical representation output by the detector as the state of the analog system 300 to a set of pixel values defining an image. The computer system 806 may be the same computer system 800 used to process the initial input to the task or a different computer system. The computer system may be configured to display the resulting image within a user interface in response to a user's input text string or to store the image to a database.

An analog implementation of a diffusion model may be made available to a user via a cloud-based service. The user may provide a set of inputs to a pre-trained restoration model via a user device coupled to the cloud-based service, which comprises the computer system 800, analog system 300 and computer system 806 shown in FIG. 8. The system of FIG. 8 is then applied as described above to generate an output at computer system 806 suitable for output to the user of the device and corresponding to the set of inputs provided. The computer system 806 of the cloud-based service then communicates the output to the user device via the cloud network.

FIG. 9 schematically shows a non-limiting example of a computing system 900, such as a computing device or system of coupled computing devices which can be configured to implement the digital processing of the computer system 800 and 806 described above before and after the application of the analog diffusion model, as well as the detector 804 and the training of the restoration model in the digital domain. Computing system 900 is shown in simplified form. Computing system 900 includes a logic processor 902, volatile memory 904, and a non-volatile storage device 906. Computing system 900 may optionally include a display subsystem 908, input subsystem 910, communication subsystem 912, and/or other components not shown in FIG. 9.

Logic processor 902 comprises one or more physical (hardware) processors configured to carry out processing operations. For example, the logic processor 902 may be configured to execute instructions that are part of one or more applications, programs, routines, libraries, objects, components, data structures, or other logical constructs. The logic processor 902 may include one or more hardware processors configured to execute software instructions based on an instruction set architecture, such as a central processing unit (CPU), graphical processing unit (GPU) or other form of accelerator processor. Additionally or alternatively, the logic processor 902 may include a hardware processor(s)) in the form of a logic circuit or firmware device configured to execute hardware-implemented logic (programmable or non-programmable) or firmware instructions. Processor(s) of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 902 may be virtualized and executed by remotely accessible, networked computing devices configured in a cloud-computing configuration. In such a case, these virtualized aspects are run on different physical logic processors of various different machines.

Non-volatile storage device 906 includes one or more physical devices configured to hold instructions executable by the logic processor 902 to implement the methods and processes described herein. When such methods and processes are implemented, the state of non-volatile storage device 906 may be transformed—e.g., to hold different data. Non-volatile storage device 906 may include physical devices that are removable and/or built-in. Non-volatile storage device 906 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 906 may include non-volatile, dynamic, static, read/write, read-only, sequential-access, location-addressable, file-addressable, and/or content-addressable devices.

Volatile memory 904 may include one or more physical devices that include random access memory. Volatile memory 904 is typically utilized by logic processor 902 to temporarily store information during processing of software instructions.

Aspects of logic processor 902, volatile memory 904, and non-volatile storage device 906 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example. The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904.

Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). For example, as described above, for an image creation application, the image represented by the output of the diffusion model may be displayed to a user via a graphical user interface of the computer system 806, or alternatively the computer system 806 may be in communication via a network with a user device having a graphical user interface configured to display the image.

As the herein-described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices. When included, input subsystem 910 may comprise or interface with one or more user-input devices such as a keyboard, mouse, touch screen, or game controller.

In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 900 to send and/or receive messages to and/or from other devices via a network such as the internet. For example, as described above, the computer system 900 may be in communication with a user device via a cloud network or the internet, via which user inputs can be transmitted to the computer system 900 and outputs of the model may be communicated to a user device.

The term computer readable media as used herein includes computer storage media. Computer storage media may include volatile and non-volatile, removable and nonremovable media (e.g., volatile memory 904 or non-volatile storage 906) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 900 or a component device thereof). Computer storage media does not include a carrier wave or other propagated or modulated data signal.

Communication media are be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

In accordance with a first example of the present disclosure there is provided a device comprising:

analog restoration model circuitry comprising: a first output, and a first input, the analog restoration model circuitry being configured to denoise in an analog processing domain an analog signal received at the first input, resulting in a first analog denoised signal at the first output;

analog noise injection circuitry comprising: a second output, and a second input coupled to the first output of the analog restoration model circuitry, the analog noise injection circuitry being configured to combine in the analog processing domain a first analog scaled noise signal with the first analog denoised signal, resulting in a first analog noise-injected signal at the second output; and

analog feedback circuitry configured to couple the second output of the analog noise injection circuitry to the first input of the analog restoration model circuitry, and thereby cause the analog restoration model circuitry to denoise in the analog processing domain the first analog noise-injected signal, resulting in a second analog denoised signal at the first output, which in turn causes the analog noise injection circuitry to combine in the analog processing domain a second analog scaled noise signal with the second analog denoised signal, resulting in a second analog noise-injected signal at the second output.

In some examples, the analog noise injection circuitry is configured to:

multiply in the analog processing domain a constant analog noise signal with a first analog noise scaling signal, resulting in the first analog scaled noise signal, and

multiply in the analog processing domain the constant analog noise signal with a second analog noise scaling signal, resulting in the second analog scaled noise signal.

In some examples, the device comprises:

digital-to-analog converter (DAC) circuitry coupled to the analog noise injection circuitry, and configured to:
generate the first analog noise scaling signal based on a first digital noise scaling factor received as input, and
generate the second analog noise scaling signal based on a second digital noise scaling factor received as input

In some examples, the DAC circuitry is configured to generate the constant analog noise signal based on a constant noise vector received as input.

In some examples, the device comprises:

analog noise generation circuitry coupled to the analog noise injection circuitry, wherein the analog noise injection circuitry is configured to generate the first analog noise-injected signal and the second analog noise-injected signal using the analog noise generation circuitry.

In some examples, the analog noise injection circuitry is configured to:

multiply in the analog processing domain a first analog noise scaling signal with a first analog noise signal generated by the analog noise generation circuitry when operating with a first noise variance, resulting in the first analog scaled noise signal, and

multiply in the analog processing domain a second analog noise scaling signal with a second analog noise signal generated by the analog noise generation circuitry when operating with a second noise variance, resulting in the second analog scaled noise signal.

In some examples, the analog feedback circuitry is configured cause the analog restoration model circuitry to denoise in the analog processing domain the second analog noise-injected signal, resulting in a third analog denoised signal at the first output, which in turn cases the analog noise injection circuitry to combining a third analog scaled noise signal with the third analog denoised signal, resulting in a third analog noise-injected signal at the second output.

In some examples, the analog feedback circuity is configured to maintain coupling of the second output of the analog noise injection circuitry to the first input of the analog restoration model circuitry, which causes the analog noise injection circuitry to generate a series of analog noise-injected signals at the second output based on successive feedback though the analog restoration model circuitry and the analog noise injection circuitry.

In some examples, the device comprises a detector configured to detect invariance between an n^{th} analog noise-injected signal of the series of analog noise-injected signals and an (n+1)^{th} analog noise injected signal of the series of analog noise-injected signals.

In some examples, the analog restoration model circuitry comprises optical analog circuitry.

In some examples, the analog noise injection circuitry comprises electrical analog circuitry.

In some examples, the analog restoration model circuitry comprises optical analog matrix or tensor multiplication circuitry and electrical analog non-linear transformation circuitry.

In some examples, the device is configured to generate the second analog noise-injected signal in dependence on a biasing signal.

In some examples, the analog restoration model circuitry comprises an analog summer configured to sum the analog first noise-injected signal with the biasing signal.

In some examples, the (n+1)^{th} analog noise injected signal encodes image data or audio data.

In accordance with a second example of the present disclosure there is provided a computer-implemented method comprising:

denoising in an analog processing domain an analog signal received at a first input of analog restoration model circuitry, resulting in a first analog denoised signal at a first output of the analog restoration model circuitry;

combining in the analog processing domain a first analog scaled noise signal with the first analog denoised signal, resulting in a first analog noise-injected signal at a second output of the analog noise injection circuitry;

denoising by the analog restoration model circuitry in the analog processing domain the first analog noise-injected signal, resulting in a second analog denoised signal at the first output; and

combining by the analog noise injection circuitry in the analog processing domain a second analog scaled noise signal with the second analog denoised signal, resulting in a second analog noise-injected signal at the second output.

In some examples, the method comprises causing the analog noise injection circuitry to generate a series of analog noise-injected signals at the second output based on successive feedback though the analog restoration model circuitry and the analog noise injection circuitry.

In some examples, the method comprises:

detecting invariance between an nth analog noise-injected signal of the series of analog noise-injected signals and an (n+1)^{th} analog noise injected signal of the series of analog noise-injected signals;

reading the (n+1)^{th} analog noise injected signal in a digital domain, resulting in an output vector;

decoding the output vector in the digital domain, resulting in an output object.

In some examples, generating an output object comprises generating image data or audio data.

In some examples, the second analog noise-injected signal encodes image data or audio data.

1. A device comprising:
analog restoration model circuitry comprising: a first output, and a first input, the analog restoration model circuitry being configured to denoise in an analog processing domain an analog signal received at the first input, resulting in a first analog denoised signal at the first output;
analog noise injection circuitry comprising: a second output, and a second input coupled to the first output of the analog restoration model circuitry, the analog noise injection circuitry being configured to combine in the analog processing domain a first analog scaled noise signal with the first analog denoised signal, resulting in a first analog noise-injected signal at the second output; and
analog feedback circuitry configured to couple the second output of the analog noise injection circuitry to the first input of the analog restoration model circuitry, and thereby cause the analog restoration model circuitry to denoise in the analog processing domain the first analog noise-injected signal, resulting in a second analog denoised signal at the first output, which in turn causes the analog noise injection circuitry to combine in the analog processing domain a second analog scaled noise signal with the second analog denoised signal, resulting in a second analog noise-injected signal at the second output.

2. The device of claim 1, wherein the analog noise injection circuitry is configured to:
multiply in the analog processing domain a constant analog noise signal with a first analog noise scaling signal, resulting in the first analog scaled noise signal, and
multiply in the analog processing domain the constant analog noise signal with a second analog noise scaling signal, resulting in the second analog scaled noise signal.

3. The device of claim 2, comprising:
digital-to-analog converter (DAC) circuitry coupled to the analog noise injection circuitry, and configured to:
generate the first analog noise scaling signal based on a first digital noise scaling factor received as input, and
generate the second analog noise scaling signal based on a second digital noise scaling factor received as input.

4. The device of claim 3, wherein the DAC circuitry is configured to generate the constant analog noise signal based on a constant noise vector received as input.

5. The device of claim 1, comprising:
analog noise generation circuitry coupled to the analog noise injection circuitry, wherein the analog noise injection circuitry is configured to generate the first analog noise-injected signal and the second analog noise-injected signal using the analog noise generation circuitry.

6. The device of claim 5, wherein the analog noise injection circuitry is configured to:
multiply in the analog processing domain a first analog noise scaling signal with a first analog noise signal generated by the analog noise generation circuitry when operating with a first noise variance, resulting in the first analog scaled noise signal, and
multiply in the analog processing domain a second analog noise scaling signal with a second analog noise signal generated by the analog noise generation circuitry when operating with a second noise variance, resulting in the second analog scaled noise signal.

7. The device of claim 1, wherein the analog feedback circuitry is configured cause the analog restoration model circuitry to denoise in the analog processing domain the second analog noise-injected signal, resulting in a third analog denoised signal at the first output, which in turn cases the analog noise injection circuitry to combining a third analog scaled noise signal with the third analog denoised signal, resulting in a third analog noise-injected signal at the second output.

8. The device of claim 1, wherein the analog feedback circuity is configured to maintain coupling of the second output of the analog noise injection circuitry to the first input of the analog restoration model circuitry, which causes the analog noise injection circuitry to generate a series of analog noise-injected signals at the second output based on successive feedback though the analog restoration model circuitry and the analog noise injection circuitry.

9. The device of claim 8, comprising a detector configured to detect invariance between an nth analog noise-injected signal of the series of analog noise-injected signals and an (n+1)^{th} analog noise injected signal of the series of analog noise-injected signals.

10. The device of claim 9, wherein the (n+1)^{th} analog noise injected signal encodes image data or audio data.

11. The device of claim 1, wherein the analog restoration model circuitry comprises optical analog circuitry.

12. The device of claim 1, wherein the analog noise injection circuitry comprises electrical analog circuitry.

13. The device of claim 1, wherein the analog restoration model circuitry comprises:
optical analog matrix or tensor multiplication circuitry; and
electrical analog non-linear transformation circuitry.

14. The device of claim 1, configured to generate the second analog noise-injected signal in dependence on a biasing signal.

15. The device of claim 14, wherein the analog restoration model circuitry comprises an analog summer configured to sum the analog first noise-injected signal with the biasing signal.

16. A computer-implemented method comprising:
denoising in an analog processing domain an analog signal received at a first input of analog restoration model circuitry, resulting in a first analog denoised signal at a first output of the analog restoration model circuitry;
combining in the analog processing domain a first analog scaled noise signal with the first analog denoised signal, resulting in a first analog noise-injected signal at a second output of the analog noise injection circuitry;
denoising by the analog restoration model circuitry in the analog processing domain the first analog noise-injected signal, resulting in a second analog denoised signal at the first output; and
combining by the analog noise injection circuitry in the analog processing domain a second analog scaled noise signal with the second analog denoised signal, resulting in a second analog noise-injected signal at the second output.

17. The method of claim 16, comprising causing the analog noise injection circuitry to generate a series of analog noise-injected signals at the second output based on successive feedback though the analog restoration model circuitry and the analog noise injection circuitry.

18. The method of claim 17, comprising:
detecting invariance between an nth analog noise-injected signal of the series of analog noise-injected signals and an (n+1)^{th} analog noise injected signal of the series of analog noise-injected signals;
reading the (n+1)^{th} analog noise injected signal in a digital domain, resulting in an output vector;
decoding the output vector in the digital domain, resulting in an output object.

19. The method of claim 18, wherein generating an output object comprises generating image data or audio data.

20. The method of claim 16, wherein the second analog noise-injected signal encodes image data or audio data.
